(19) United States
(12) Patent Application Publication
(10) Pub. No.: US 2009/0049006 A1
(43) Pub. Date: Feb. 19, 2009

(54) METHOD AND SYSTEM FOR PROCESSING KNOWLEDGE

(76) Inventors: William D. LeFebvre, West Chester, PA (US); Francis C. Rowland, Surrey (GB); Nicholas A. Kaye, Berkshire (GB)

Correspondence Address: Zilka-Kotab, PC, P.O. BOX 721120, SAN JOSE, CA, 95172-1120, US

(21) Appl. No.: 12/261,994

(22) Filed: Oct. 30, 2008

Related U.S. Application Data
(63) Continuation of application No. 10/943,325, filed on Sep. 17, 2004.

(30) Foreign Application Priority Data
Sep. 17, 2003 (GB) 0321736.1

(51) Int. Cl. G06F 17/30

(52) U.S. Cl. 707/1; 707/E17.001

(57) ABSTRACT

The invention provides a knowledge sharing method for supporting mobile workers before, during and after visiting a location, organisation or individual as part of their day to day activities. It achieves this through a knowledge management system which has a database for storing knowledge specific to a plurality of entities such as customers, maintenance locations, client organisation or individuals, for example. The database provides stored knowledge to a user in response to said user providing an identity of one of said plurality of entities. The retrieved knowledge being provided to the user in audio form on a voice enabled interface between the user and the system. The retrieved knowledge is provided to said user from the knowledge stored in the database specific to that entity. This knowledge may be based on information provided by other users of the knowledge management system.

### RELATED APPLICATION(S)

The present application is a continuation of a U.S. patent application filed Sep. 17, 2004 under application Ser. No. 10/943,325 which, in turn, claims the priority of a United Kingdom patent application filed Sep. 17, 2003 under application number 0321736.1, both of which are incorporated herein by reference.

### FIELD OF THE INVENTION

The present invention relates to a method and a system for processing knowledge. More specifically, the present invention concerns a method and a system for the collection and processing of knowledge about specific entities from system users and the sharing of such knowledge with system users. More particularly, the present invention is directed to providing a voice enabled knowledge sharing system for mobile workers and their managers on field or customer visits.

### BACKGROUND TO THE INVENTION

The information, insights and rules of thumb that individuals use when taking actions and decisions are collectively known as knowledge. In today's business environment, technology and globalisation have combined to make the management of knowledge an imperative for organisations of all sizes. With the exponential growth in information and increasing change in the external environment, businesses are placing a premium on knowledge management to support innovation and improvements in operational efficiency. However, few of these benefits are achievable if an individual's knowledge cannot be shared with others in their organization or profession.

The idea and practice of knowledge sharing is not new. It is at the heart of all significant human activity, including technological and economic development. Those involved acquire know-how and expertise as to how an activity might be successfully conducted. What is learned in the process can be captured and communicated to others, enabling them to build on the earlier experiences of their peers and to avoid making the same mistakes. However, while much of the know-how can be encoded in documents, even in highly sophisticated organisations, the most valuable knowledge—the ‘know-how’ in terms of what really gets results and what mistakes to avoid—often resides mainly in people's minds.

Historically, knowledge-sharing mechanisms such as meetings, workshops, conferences, apprenticeships and less formal networks and social interactions, have ensured that tacit knowledge residing. In people's minds is communicated to others in an organisation. However, changing working practices, led by developments in information technology and more pervasive and less expensive communications media, have resulted in fewer opportunities to formally share tacit knowledge with a greater reliance being placed on making this tacit knowledge available through email, intranets, websites, telephone, etc.

The changing nature of working practices has resulted in a number of barriers to effective knowledge sharing. These include individuals having too little time to share knowledge, not using the appropriate tools and not using the knowledge available to them because of information overload. Further, communication theory suggests that in a conversation, only 7% of the message is in the words, 38% in the voice (intonation etc) and 55% in the body language of the speaker. Current approaches to sharing knowledge through information technology require basic ‘word’ communication, without voice or physiology guidance, resulting in an inefficient process.

Other challenges to effective knowledge sharing using text based approaches are clearly evident in roles that require workers to be mobile. In sales, installation and maintenance, consulting and other service professions, employees may have little or no contact with their peers. This has the effect of reducing the sharing of applied, practical knowledge gained in the course of their daily activities. Use of telephone, email and other mobile communication systems has increased, to enable these employees to stay in touch. However, these fall short of providing an efficient organizational knowledge-sharing platform as the communication is typically only from one person to another person or system; it is not structured, cannot be managed effectively and is not delivered in a an easily understood manner.

In an attempt to meet this need, mobile computing platforms have been developed which are capable of running applications that make the sharing of knowledge with mobile workers, a realistic proposition. But these devices have a high cost of ownership and are not always convenient to use. Further, because they use text based data entry mechanisms, their ability to capture information and insights, that are useful in knowledge sharing, is limited. They may be ideal for managing transactions with data, but not for interactions with knowledge.

### OBJECT OF THE INVENTION

It is therefore an object of the present invention to provide a means of mitigating or obviating disadvantages associated with known knowledge sharing schemes, methods and systems.

### SUMMARY OF THE INVENTION

Accordingly, the present invention provides in a first aspect a knowledge management system having a database for storing knowledge specific to a plurality of entities, said database being arranged to provide stored knowledge to a user in response to said user providing an identity of one of said plurality of entities, said knowledge being provided to said user in audio form on a voice enabled interface between the user and the system, wherein the knowledge provided to said user is retrieved from the knowledge stored in the database specific to that entity and the knowledge stored in the database for an entity comprises, is based on or is derived from information provided by a user.

Providing knowledge to a user through audio feedback is a more user friendly medium than a text message, for example. In addition, audio feedback of information can be effected by a telephone or telephony enabled device which greatly increases the accessibility of the system to a user.

Preferably, the knowledge stored in the database comprises data, audio recordings or a combination thereof.

Where stored knowledge comprises an audio recording which is played back to the user on a voice enabled interface, e.g. a telephone, the user gains the benefit of obtaining tacit knowledge from the intonation of the spoken information embodied in the audio recording which would otherwise be unavailable through other forms of feedback media.

The knowledge stored in the database for each entity may be categorised.

Preferably, the categories used to categorise the knowledge stored in the database for an entity are specific to that entity.

By allowing knowledge for an entity to be stored in the database using categories and sub-categories specific to that entity rather than a global categorisation system, allows a user seeking knowledge from the system to more quickly drill down through the levels of categorisation to reach the elements of knowledge they require.

An entity may comprise a location, a person, an organisation, a process or any combination thereof.

Preferably, the knowledge stored for an entity in the database comprises, is based on or is derived from information provided by a previous user or users of the system.

This allows so called tacit knowledge that would ordinarily reside in the mind of the user to be made available to other users. Such knowledge could comprise the user's experience with an object relating to an entity or an insight on how to best approach a non-standard issue.

The information provided by a previous user of the system may be stored as an audio recording.

Alternatively, the information provided by a previous user of the system may be stored as text data and outputted to a subsequent user of the system as speech synthesised text on the voice enabled interface.

The knowledge stored for an entity in the database may be based on or derived from information provided by a plurality of previous users, said stored knowledge comprising a system administrator's or an expert's precis of said information.

Where the information provided by previous users addresses a technical issue, for example, the system may arrange for an expert to analyse the inputs provided by the previous users in order to distil from these inputs a more concise element of knowledge to be shared with other users. This may require the expert to officiate conflicting inputs. In the case of user inputs on an administrative issue, a system administrator can readily assess the various users inputs and post an appropriate knowledge element into the database for the entity associated with said inputs. In either case, the expert or the administrator can post the element of knowledge to the database as an audio recording or as a text based element.

The system may have an application server for processing user connections to the database. An example of such a server is the International Business Machines Websphere server (Websphere is a trade name of IBM) or the Apache Tomcat sever (Apache Tomcat is a trade name of the Apache Software Foundation) or any open standard J2EE (the Java 2 Platform, Enterprise Edition) compliant application server.

Preferably, the system has a voice gateway for providing the voice enabled interface between the system and a user and the voice gateway has a voice recognition processor for processing user voice inputs to the system.

The voice gateway allows the voice enabled interface between the user and the system to be bi-directional so that, not only do users receive retrieved elements of knowledge from the database in an audio, spoken or speech synthesised, format, but the users can speak their inputs to the system. Consequently, the interface between the user and the system could comprise a plain old telephone system (POTS) handset or a cellular system handset which greatly increases accessibility of the systems to users.

Preferably, the application server enables a user to browse or search the knowledge stored for an entity in the database in response to the user identifying said entity and to do so using a search engine. The voice gateway enables a user to use spoken words as key words for the search engine.

In another aspect, the invention provides a method of managing knowledge collection/retrieval in a system having a database for storing knowledge, comprises the steps of: arranging elements of stored knowledge in the database such that each element is associated with a specific one of a plurality of known entities; and providing one or more elements of stored knowledge to a user in response to said user providing an identity of one of said entities, the one of more elements of stored knowledge being outputted to the user on a voice enabled interface between the user and the system, wherein the one or more elements of stored knowledge provided to said user are retrieved from the elements of knowledge stored in the database associated with the identified entity and the knowledge stored in the database for an entity comprises, is based on or is derived from information provided by a user.

The method may include the step of enabling a user to identify an entity by speaking any one or a combination of its name, reference code or job number.

Alternatively, the identity of an entity may be derived automatically from a caller line number, for example.

The method may include the step of requiring a user to provide the system with a user identification, said user identifying its user identification by speaking any one or a combination of its name, a user identity number or a pre-recorded word or words. The system may use a voice print comparison technique to derive the identity of the user rather than voice recognition of specific spoken words.

The method may include the step of the application server issuing to a user a request for information on a specific entity in response to said user identifying that entity or providing their user identity.

This provides one means by which the system can collect user knowledge and do so in an intelligent manner. A system administrator or expert may identify gaps in the knowledge stored in the database relating to a specific entity and may thus instruct the application server to trigger a request for a user to provide this information when that entity is next identified to the system in association with a user request for knowledge. Alternatively, the administrator or expert may identify a user best placed to provide the requested information and may therefore set the application server to trigger an information request the next time that user is identified to the system. As a further alternative, the conditions for triggering an information request from the application server may comprise a combination of the entity's identity and the user's identity.

In a further aspect, the invention provides a database for a knowledge management system as aforesaid.

The database memory may be logically divided into a first memory area containing text data and a second area of memory containing digitally encoded audio recordings or references to them stored on a file server.

In a yet further aspect of the invention, there is provided a voice gateway programmed to implement a method of managing knowledge collection/retrieval in a system having a database for storing knowledge, the method comprising the steps of: arranging elements of stored knowledge in the database such that each element is associated with a specific one of a plurality of known entities; and providing one or more elements of stored knowledge to a user in response to said user providing an identity of one of said entities, the one or more elements of stored knowledge being outputted to the user on a voice enabled interface between the user and the system, wherein the one or more elements of stored knowledge provided to said user are retrieved from the elements of knowledge stored in the database associated with the identified entity and the knowledge stored for an entity in the database comprises, is derived from or is based on information provided by a user.

In a yet further aspect, the invention provides a voice gateway for a knowledge management system as aforesaid, wherein said voice gateway includes a voice recognition processor for processing users' spoken inputs to the system.

In a still further aspect of the invention, there is provided a computer program on a machine readable medium for implementing a method of managing knowledge collection/retrieval in a system having a database for storing knowledge, the method comprising the steps of: arranging elements of stored knowledge in the database such that each element is associated with a specific one of a plurality of known entities; and providing one or more elements of stored knowledge to a user in response to said user providing an identity of one of said entities, the one or more elements of stored knowledge being outputted to the user on a voice enabled interface between the user and the system, wherein the one or more elements of stored knowledge provided to said user are retrieved from the elements of knowledge stored in the database associated with the identified entity and the knowledge stored for an entity in the database comprises, is derived from or is based on information provided by a user.

In a still further aspect of the invention, there is provided a computer implemented method comprising the steps of arranging elements of stored knowledge in a database of a knowledge management system such that each element is associated with a specific one of a plurality of known entities; and providing one or more elements of stored knowledge to a user in response to said user providing an identity of one of said entities, the one or more elements of stored knowledge being outputted to the user on a voice enabled interface between the user and the system, wherein the one or more elements of stored knowledge provided to said user are retrieved from the elements of knowledge stored in the database associated with the identified entity and the knowledge stored for an entity in the database comprises, is derived from or is based on information provided by a user.

### DESCRIPTION OF DRAWINGS

FIG. 1 is a block diagram of a preferred embodiment of a knowledge management system in accordance with the invention;

FIG. 2 is a block diagram of the voice gateway of the knowledge management system of FIG. 1:

FIG. 3 is a block diagram of the database of the knowledge management system of FIG. 1;

FIG. 4 is a flow diagram of a user connection and authentication process in the knowledge management system;

FIG. 5 is a flow diagram of an open visit process in the knowledge management system;

FIG. 6 is a flow diagram of a user knowledge retrieval process in the knowledge management system;

FIG. 7 is a flow diagram of a knowledge collection and close visit/iob process in the knowledge management system; and

FIG. 8 is a flow diagram of a management review process in the knowledge management system.

### DESCRIPTION OF A PREFERRED EMBODIMENT

The foregoing and further features of the present invention will be more readily understood from the following description of a preferred embodiment, by way of example only and without limitation to the scope of the invention, having regard to the accompanying drawings.

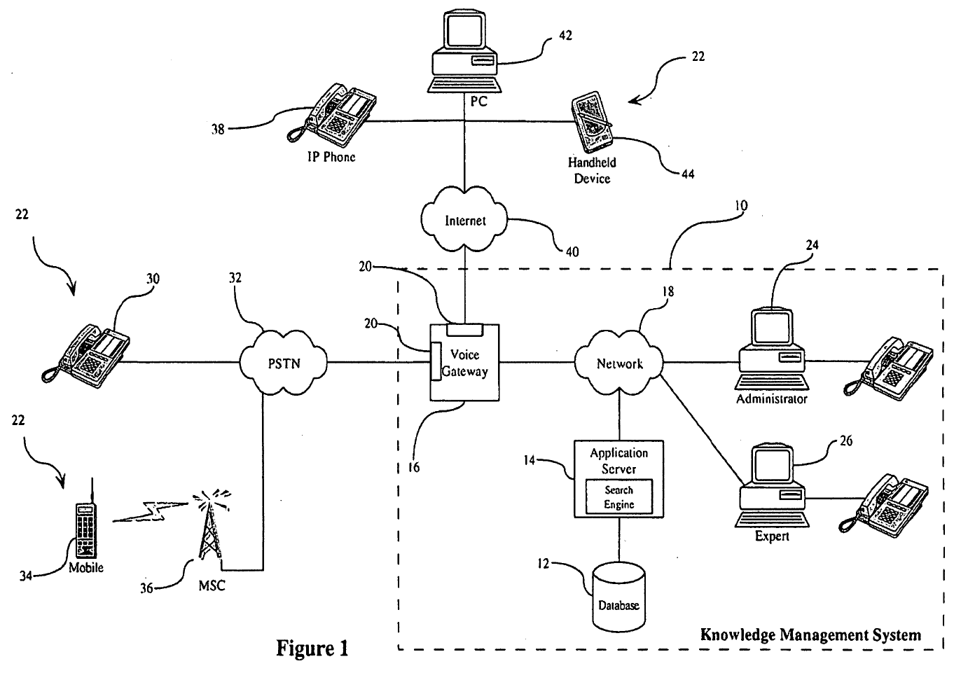

Referring to FIG. 1, there is shown a preferred embodiment of a knowledge management system 10 in accordance with the invention. This comprises a database 12 for storing knowledge specific to a plurality of entities such as organisations, locations, people, processes or the like. The database 12 is controlled by an application server 14 which processes users' requests to retrieve elements of knowledge associated with said entities stored in the database 12. The application server 14 and database 12 are connected to a voice gateway 16 over a network 18 such as a local area network (LAN). The voice gateway 16 establishes a voice enabled interface 20 between users 22 and the system 10. It will be understood that the application server 14 and the database 12 may themselves be connected via the LAN 18 although this is not illustrated here. It will also be appreciated that the application server 14, the database 12 and the voice gateway 16 may be connected by any suitable network known to a skilled artisan including an intranet, the internet, a wide area network (WAN), etc.

In the preferred embodiment, the knowledge management system 10 includes a system administrator 24 and a system expert 26. In each case, the administrator 24 and expert 26 may be human operatives although the provision of software implemented agents (not shown) as administrators and experts is not outside the scope of this invention. The system administrator and expert may also be connected to the application server through the LAN or another suitable network.

The voice gateway 16 is a hardware and software platform that handles interactions between callers (users) and the application server. The voice gateway provides voice enabled interfaces 20 for users 22 of the system. The users 22 may connect to the system by any suitable telephony enabled device such as a plain old telephone system (POTS) handset 30 connected to the voice gateway by a public switched telephone network (PSTN) 32, a mobile telephony handset 34 connected to the voice gateway via a mobile switching centre (MSC) 36 and PSTN, an internet protocol (IP) telephony handset 38 connected to the voice gateway by the internet 40, a telephony enabled personal computer (PC) 42 connected to the voice gateway by the internet 40 and a handheld telephony enabled PC device 44. Such devices are known to the skilled artisan so need not be discussed here. It will be appreciated that whilst said user devices are shown as being connected to the knowledge management system by external networks 32, 40, said devices may reside within the same private network such as a corporate network, for example, as the knowledge management system.

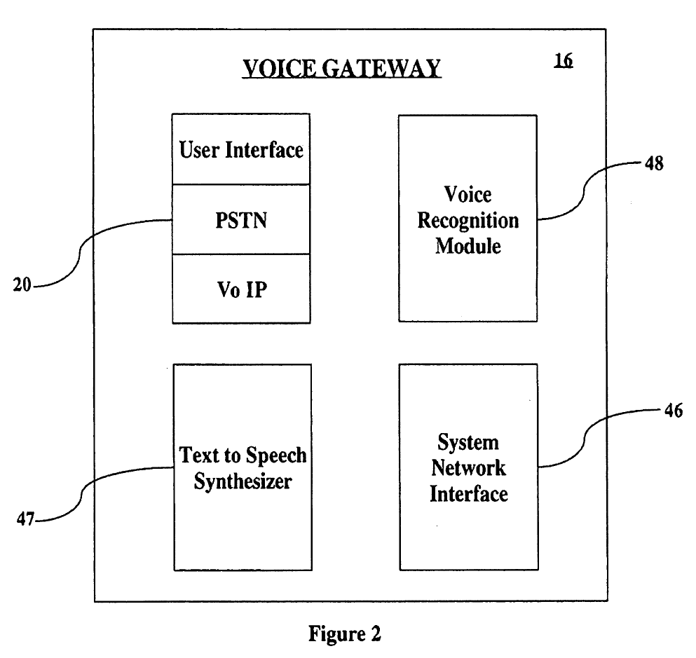

As depicted in FIG. 2, the voice gateway 16 provides a number of user interfaces 20 to enable different classes or types of telephony enabled devices to connect to the knowledge management system 10. It also provides a system network interface 46 which may comprise an Ethernet jack, for example, for connection to the LAN 18. The voice gateway 16 also comprises a voice recognition module 48 running voice recognition software to process spoken user inputs. Any suitable voice recognition software may be employed.

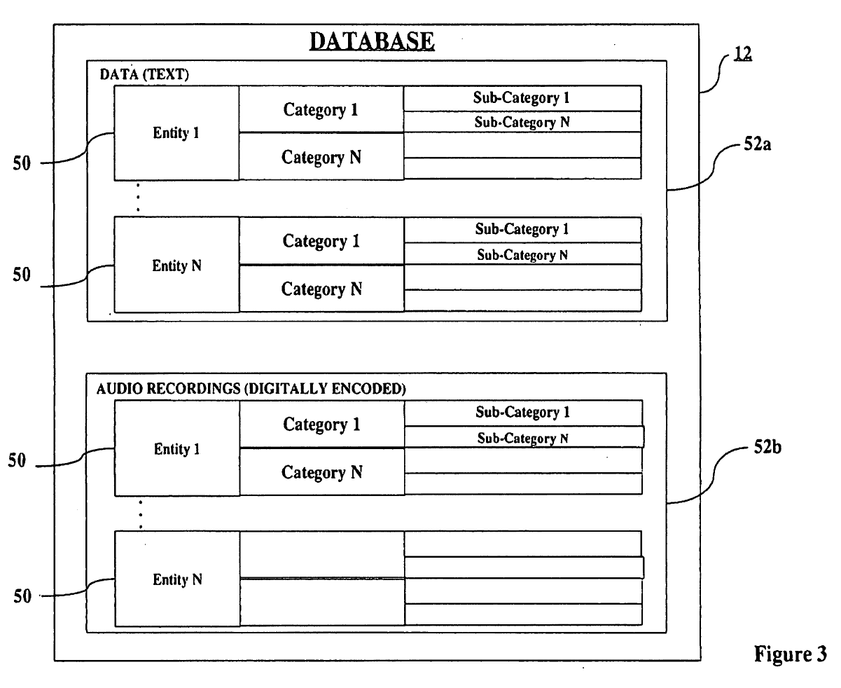

The database 12 is arranged to store elements of knowledge specific to a plurality of entities (1 to N) 50 and to arrange these elements of knowledge in a hierarchical fashion through various levels of categorisation. This can be best seen in FIG. 3 in which it is shown that a memory of the database is logically structured to comprise two parts 52a, 52b. The first part 52a stores elements of knowledge consisting of text data and the second part 52b stores elements of knowledge comprising digitally encoded audio recordings or references to them stored as files on a file server (not shown). The data referencing the audio recordings stored in the second part 52b of the database may comprise a file path and name for each audio recording files stored on the file server. Thus, the elements of knowledge stored for each entity may comprise text data, audio recordings or a combination of these. Each part of the database memory logically comprises a memory section for each entity with the elements of knowledge for that entity being stored in a hierarchy of categories and sub-categories of categories, etc. Whilst in FIG. 2 the elements of knowledge for an entity labelled “Entity 1” are shown as having only two levels of categorisation, it will be understood that any suitable number of levels can be employed and may not be the same for each entity.

The database may use a common rules based scheme for categorising the elements of knowledge for each entity or an intelligent scheme that allows the categories for each entity to be dynamically developed.

The knowledge management system may employ more than one database. These databases may be external to the knowledge management system being operated by knowledge providers.

Description of an Implementation of the System.

The following is a description of an implementation of the knowledge management system of the invention as a means of illustrating the manner by which the system collects and processes knowledge from users and makes such knowledge available to users. The following description should not be considered limitative of the scope of the present invention.

This implementation is directed to managing knowledge gained from engineers' field visits. A field visit comprises a location (entity) e.g. a building, having an equipment to be serviced. The visit consists of an engineer's entry, activity and exit from the building. A job may comprise one or more visits by the engineer or another engineer to produce a tangible outcome. Finally, a system manager (expert) overseas the activity being undertaken by the engineers at the location.

At the start, any time during or at the end of a visit the engineer can call the system from a PSTN handset 30 or mobile telephone handset 34 or any other suitable telephony enabled device 38, 42, 44 supporting voice over Internet Protocol (VoIP), for example, to a number that routes the call to the voice gateway 16. The voice gateway 16 loads a call management application from the application server 14 and takes control of the incoming call, using speech recognition, making audio recordings and/or using DTMF tones to accept input from the engineer, and playing audio recordings or using a text to speech synthesiser 47 to play outgoing information, instructions or caller options.

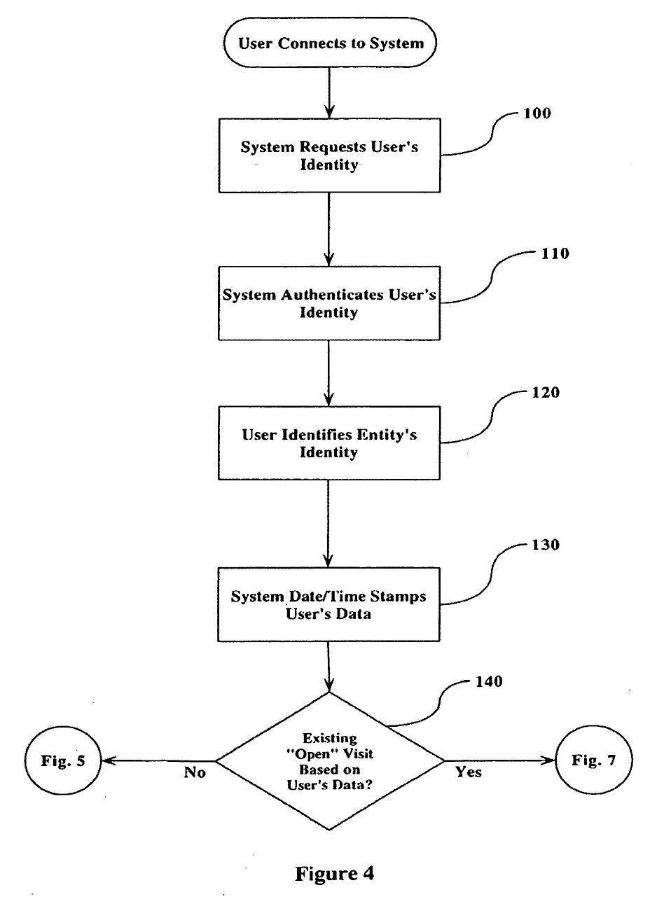

Referring now to FIG. 4 which comprises a flow diagram of a user (for user read engineer) call connection and authentication process that the engineer must complete to gain access to the knowledge management system. The voice gateway on taking control of the incoming call asks the engineer to identify himself (step 100). This may be achieved through the engineer entering a user identification number and/or a personal identification number (PIN) by speaking these or using DTMF tones, or by saying his name and/or saying a word or phrase that is compared with an existing voiceprint pre-recorded by the engineer and stored in the database for authentication of identity purposes (step 110). Alternatively, the voice gateway may derive an identity of the engineer through a calling identification (caller ID) number through the telephone network followed by a request for the engineer to input a PIN, or by any other suitable means. The engineer may input the PIN by speaking it. This identification step 100 provides a means of authenticating (step 110) the engineer's identity and authorise his access to the system.

The engineer then identifies the location (step 120) that is the subject of the visit by saying its name or a location reference code. In some cases this may be done automatically using a telephone fixed at the location with caller ID enabled and a database that cross references the location with the obtained caller ID number. Optionally, a unique reference number may be used to identify the location and visit, e.g. a job number.

The system records the identity and location data provided by the engineer and stores it with a time and date stamp (step 130). The engineer's identity and/or the location identity may be used as one or more levels of categorising information (knowledge) collected by the system during the call and to customise or determine which information should be outputted to the engineer.

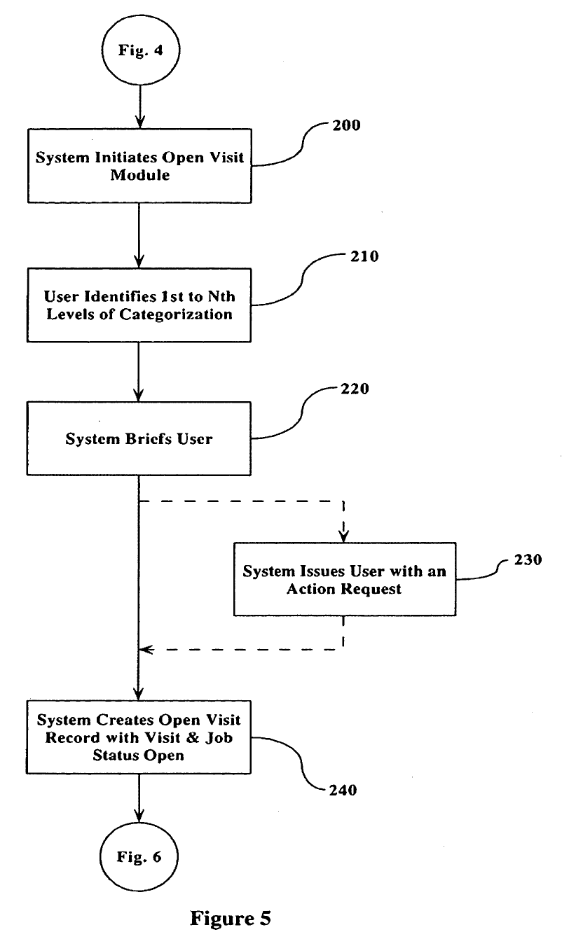

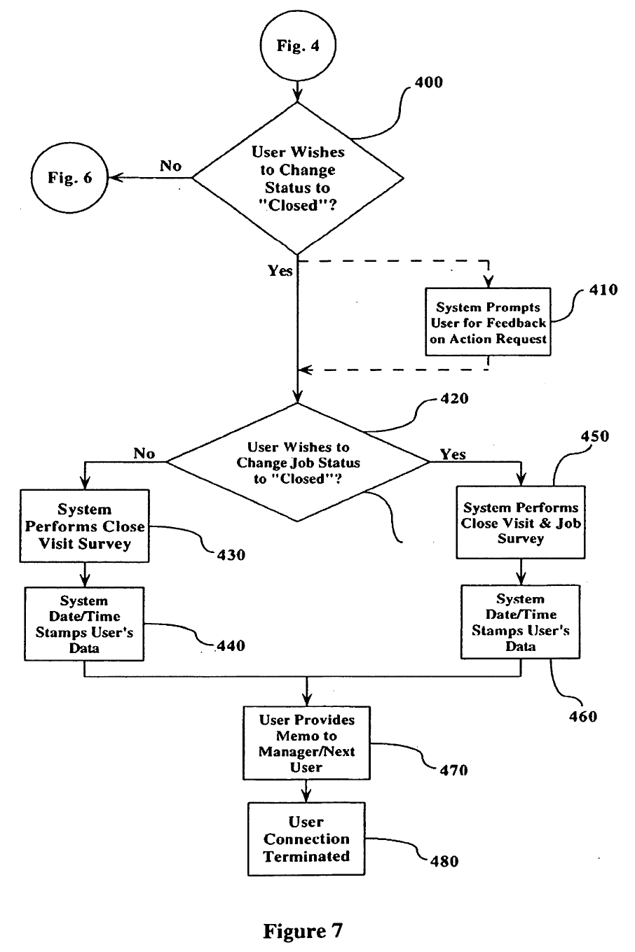

The system then checks the database using the engineer's name and location data to determine if there is an existing visit record in the database matching this profile whose visit status field is ‘OPEN’ (decision point 140). If there is no record matching this profile with an ‘OPEN’ visit status field, then the system implements an open visit module (see step 200, FIG. 5). Alternatively, if a matching ‘OPEN’ visit record is found, the system asks the user if they would like to change the visit status record to ‘close’ and close the visit or to get more information relevant to the current visit (see decision point 400, FIG. 7).

Referring to FIG. 5, this comprises a flow diagram of an open visit process. To open a visit, the system first prompts the engineer to identify the nature of the visit (step 210) from a pre-defined taxonomy. In the example implementation described here, the taxonomy may be based on the major asset groups found at the location e.g. air conditioning equipment 1 through to N, refrigeration unit 1 through to O, lighting unit 1 through to P for instance together with separate lists of possible activities that might be conducted on those assets. In the example of an air conditioning equipment, the activities list might include annual service, quarterly service, breakdown, parts replacement etc. The definition of the taxonomy is important as it can be used as the levels of categorisation used to categorise information (knowledge) collected by the system and to customise information given to the engineer. This step 210 may comprise an iterative process by which the engineer, either prompted by the system or working to a predefined protocol, delivers to the system information which precisely defines the engineer's purpose for visiting the location. The engineer uses speech as a means of delivering the information required by the system. This may be audio recorded as a means by which an administrator can later confirm against other records the purpose of the engineer's visit to that location or it can be processed by the voice gateway voice recognition module so that data representative of the information provided by the engineer is immediately available for processing.

Having collected information pertaining to the purpose of the engineer's visit to the location, the system may choose to brief the engineer (step 220) with specific information relevant to the location and the declared purpose for visiting the location. The objective of the briefing is to make the engineer more effective in any actions or decisions he may take during the visit. The briefing may include providing information about the maintenance history or status of the identified asset group, warranty information, health and safety data and insights from engineers who have previously attended the location for the same or a similar purpose. This latter information may include views on common issues encountered with the equipment or information on issues peculiar to that equipment. This latter information can be considered as tacit information, being information that has become available through the experiences of engineers who have previously undertaken the same or a similar task. Some of this information may be stored as text data that is delivered to the engineer by a speech synthesis process and some may comprise audio recordings replayed to the engineer.

The briefing may consist of a number of short messages that are played to the engineer. The messages may be predefined or dynamically generated from other data sources. Site or location briefing messages may be controlled from a central database and can be customised to play, one or more times to certain individuals, at certain dates or times, at visits to certain locations, or when undertaking certain types of jobs. In addition, the briefing messages can be classified as being mandatory (the caller has to listen to the whole message) or optional (the caller can browse a list of messages and select any they wish to hear). Mandatory briefing messages can be specified to require positive verbal responses from the caller to confirm that they have fully understood the message before the visit can proceed.

The briefing may be concluded with an optional action request by the system to the engineer (step 230). Its objective is to enable the system administrator or an expert to request a visiting engineer to undertake specific data collection task(s) in order to further the system's knowledge about specific issues or asset groups at the visited location. For instance, the system administrator could seek new insights into recurring problems with certain types of refrigeration units and establishes a request to be delivered by the system to the next engineer with a relevant skill or profile that visits that location to identify say the type of coolant gas used in the units at that location to determine if said coolant meets current regulations, for example.

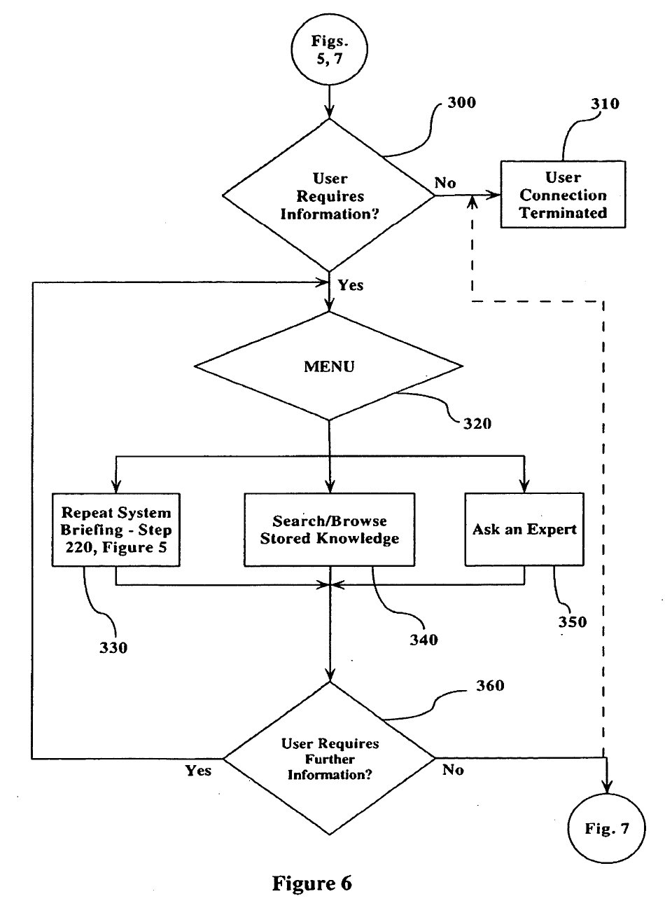

At this point the system creates a new record in the visit database with the Visit Status field and a Job Status field both set to ‘OPEN’. It then prompts the engineer to determine if he would like any more information relevant to his visit (decision point 300, FIG. 6). If they do not need any further information the system terminates the call (step 310, FIG. 6) and the engineer goes about his work.

At the start of or during a visit the engineer can direct various information requests to the system in order to improve their knowledge of issues related to the location, asset group they'are working on, job status or other information/knowledge stored in the database 12, for example. If they have previously opened a visit record then to make an information request they must call the system and go through the call connection and authentication process illustrated by FIG. 4 in order to be granted access to the knowledge management system 10. This brings them to decision point 400 of FIG. 7 for which they indicate a negative that they do not wish to change the visit status to “close”. This brings them to step 300 of FIG. 6 where they provide an affirmative for requiring information. FIG. 6 comprises a flow diagram illustrating an information/knowledge retrieval process for the knowledge management system 10 in accordance with the invention.

Having indicated a desire for information, the engineer is directed to an information menu (decision point 320) which provides a number of information retrieval options that the engineer may utilise. One option (330) is to repeat the system briefing (step 220, FIG. 5) provided when opening a visit record on a previous call. Another option (340) is to allow the engineer to browse or search information in the database relating to the entity (location) being visited. A further option (350) is to enable the engineer to ask an expert for assistance.

Exploring a knowledge repository for an entity in the database 12 can be achieved by browsing through the hierarchical categorisation of the information contained within the knowledge repository that is relevant to the visit, selecting a category before being presented with one or more subcategories in an iterative process. Elements of knowledge discovered through this process may be presented in a list that the caller can browse through. The alternative mechanism is to use spoken keywords to drill down through the levels of categorisation used to store such information in the database 12. The keywords may be selected from a predefined taxonomy that is used to search the information assets. A multimedia-indexing tool enables key word searching of audio recordings. In addition, the application server 14 may have a search engine facility responsive to keyword searching.

Alternatively the engineer can ask an expert a question. This is achieved through a semi-automated approach, capable of working in either synchronous or asynchronous modes. The engineer records a question that they would like answered. They are requested to select some categorisation criteria for the question. The system uses these criteria and other profile related information such as asset group being visited and location etc. to return a list of possible answers to the question. The engineer browses the list and if none of the existing answers provide them with the information they seek then the question is either queued for consideration by an expert at some other time, or else the engineer is routed to an appropriate expert to resolve the call in a live, one to one interaction. An extension of this basic method can also be used for managing approval for repair or replacement of an asset.

Having completed an information request, the engineer is offered the opportunity to do another information request (decision point 360). If they do not wish to do this then they are asked if they want to change the status of the visit to “close” (decision point 400, FIG. 7) and are then directed to a close visit process (figure) if the answer to this is in the affirmative. Optionally, if they indicate in the negative that they do not requires further information then the system terminates the connection rather than direct the engineer to the close visit process. If they do wish to seek further information then they are redirected to the information menu (320) and the information retrieval process can be repeated. There need be no limit to the number of repeat information retrieval requests pursued by the engineer.

On completion of the visit the engineer again calls the system to provide to the system 10 feedback in the form of information and insights generated as a consequence of their visit, and to respond to any action requests made of them. Again, when they call back into the system 10, they must complete the connection and authentication process of FIG. 4 which brings them to decision point 400, FIG. 7 where they respond in the affirmative to the prompt that they wish to change the status of the visit record to close.

FIG. 7 sets out the close visit process. Once the engineer has given an affirmative to the change visit status to close prompt, the engineer is asked if they are able to respond to the action request posed to them when they opened the visit record (step 410). This is an optional step dependent on whether any action requests were presented to the engineer. This step may be repeated for each such action request. If the engineer indicated in the affirmative, then the system uses audio recording and/or speech recognition to capture their response. The response is stored in a database for subsequent analysis by an administrator and/or expert.

Having responded to the request the engineer is asked if they have completed the job associated with the visit (decision point 420). If they have finished the visit but not the job then they complete an end of visit survey (step 430) relevant to their location and the nature of their visit. The visit record is date and time stamped (step 440) and the visit status field set to ‘CLOSED’, while the job status field is left as “OPEN”. Alternatively if the engineer has completed the visit and the job then they complete an end of job/visit survey (step 450). The visit record is date and time stamped (step 460) and the visit status field and job status field are both set to ‘CLOSED’.

The closure surveys (430, 450) are each designed to elicit insights and information from the engineer in order to capture knowledge associated with the work they have conducted at the location. The surveys may use a number of standard question and answer methods. These methods include questions with the following types of answers: a YES/NO response, a number, a predefined multiple choice, or an audio recording of predefined duration. Additionally an intelligent agent can be set up to monitor a recognised response from a caller triggering an event such as a follow up question, or routing the caller to a system administrator. The survey responses are stored in a database for subsequent analysis by administrators and/or experts.

The final interaction between the system and the engineer when dosing a visit or job, is to ask the them if they would like to record a memo for a system manager and/or a note for the next engineer visiting the location (step 470). Both the memo and the note are audio recordings of set duration. The system may provide an option for the engineer to review and change these recordings if required.

A voice memo prepared by the engineer can be routed to a system manager as an audio recording and associated information attached to an email, or through a multimedia messaging service, or flagged as a link on a control screen or presented to an administrator when the manager or administrator next calls into the system (via telephone or VoIP for instance). A note prepared by the engineer for the next engineer is stored and may be played as an optional or mandatory briefing message for the next engineer visiting the location for a same or similar purpose.

Once the engineer completes the memo and note options the system 10 terminate the connection (step 480).

The system may provide the engineer with support during a call through a help function that provides the user with detailed information about how to use the system or any one of its component parts. Such systems are known to skilled artisans so need not be discussed in detail here. At strategic points in such a help application, the help functionality is supplemented by a transfer call function, directing the caller to a live person or a message taking facility that queues messages to be resolved by a system manager/administrator/expert at some later time.

A system manager, technical expert or administrator can access the system through a voice enabled interface a graphical user interface such as a computer. The voice enabled interface is designed to provide fast and convenient access to applications run by the application server 14 to allow them to keep up to date with engineer visits and feedback information, and to manage briefing messages to engineers and information requests made by engineers. It also allows them to control a “transfer to me” option when an engineer calls in to the system such that, when the engineer has completed the connection and authentication process, they are directed to a live call with an administrator, for example bypassing the hereinbefore described system processes.

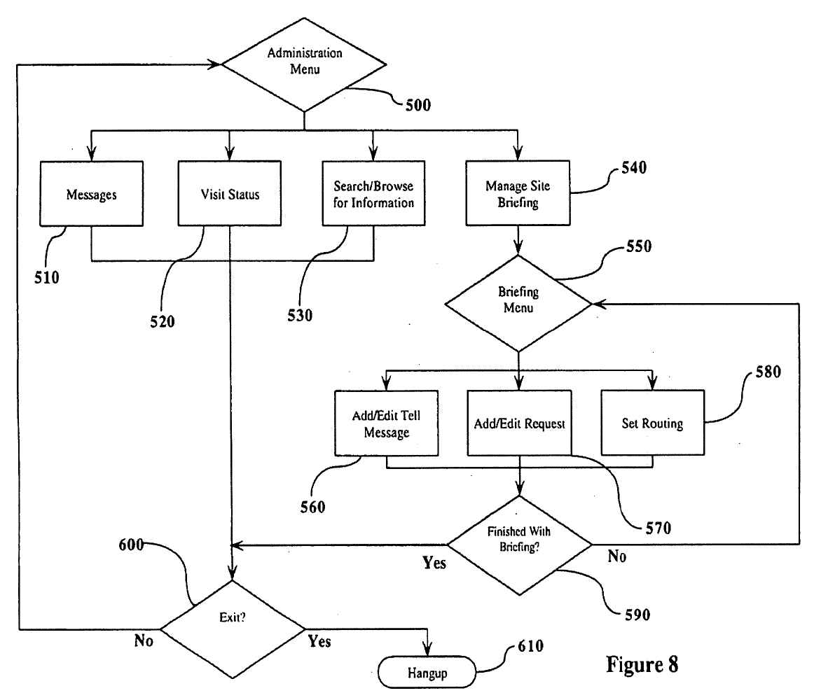

The system managers, administrators and experts may access the system through a different telephony connection than the engineers although it is envisaged that they also will be subject to an identity authentication process before being given access to an administration menu 500 (FIG. 8). Taking a system manager as an example, the menu enables the system manager to listen to messages left for them by visiting engineers, to check the status of any visits, to search or browse for information, and to manage engineer site briefings.

Selecting the message option 510 from this menu, the system manager can listen to new messages, review old ones, or have any of the messages forwarded to their email or a multimedia-messaging device. All messages sent by the engineer are retained in the visit log—a complete record of all interactions made with the system during the engineer's visit to a location.

The visit status option 520 allows the system manager to review a list of all open visits, recently closed visits, visits by location and/or outcome. The visit log of any listed visit can also be requested and reviewed by the manager.

Additionally, the system manager can search and browse a knowledge repository 530 in a like manner to a visiting engineer, as hereinbefore described.

Finally, selecting the Manage Site Briefing option 540 takes the system manager to a submenu 550 allowing them to manage “Tell Messages” 560 (briefing messages) and “Requests” 570 (system action requests) used in a visit briefing, or set a routing option for the next, or a specific, engineer, calling in from a location to be routed directly to the system manager.

Managing “Tell Messages” 560 and “Requests” 570 both use the same basic mechanism. The system manager selects the location and a list of “Tell Messages” and these are played. After hearing each item the manager can leave the list as it is, change the order in which it is played, or delete it. The manager can also record a new briefing message or action request for an engineer.

Alternatively, the system manager can set a “Set Routing” option 580 to route an engineer calling into the system directly to the system manager's telephone. The routing option can be set by location, engineer, or asset group being visited or any combination thereof. When the engineer calls in to the system, and a routing has been set, they are diverted to the system manager at the end of the normal brief, debrief or information dialog or at any other suitable point in the information collection and retrieval process. The system manager can then talk to the individual directly.

Having completed one of the Briefing Menu options the system manager is asked if they have finished managing the briefing (decision point 590). If they have, they are then returned to the end of the Administration Menu 500, which asks them if they would like to exit from the application 600. If they do then the system hangs up and terminates the connection (step 610).

The graphical user interface provides the system manager with a full range of administration and analysis functions based on the information contained within the system databases. For instance, it allows access to add, edit or delete users, locations, asset groups, survey questions or any other information used in the application. It can also use the time and date information automatically collected at the start and end of a visit for resource management or billing activities, and providing a real-Ume status monitor for control room situations, and for other purposes. Further, through analysis of the visit, survey and request results data the system manager can identify underlying trends and patterns and use this to influence operational procedures and business strategy.

In the above described example implementation of a knowledge management system in accordance with the present invention, it will be understood that many of the process steps described are not essential to the implementation of the system of the invention. For example, where the system is implemented in a corporate network, authentication of callers' identities is desirable for security reasons. However, in an open information collection, creation and sharing environment, it may not be necessary for callers to provide identification data. Equally, it may not be necessary for callers to create an open visit record or an equivalent, e.g. an open session record, in order to interact with the knowledge management system.

In another example of an implementation of the system in accordance with the invention, it may relate to a salesperson making a visit or a telephone call to a customer with an action request that the salesperson is to ask the customer about their forecast for a particular type of product. During an end of visit (or call) connection, the salesperson can provide as a voice recorded memo or, as voice recognised text/numerical data, information pertaining to the customer's predicted future need for a certain product or products. An expert in the form of a market analyst may access reports from various such salespersons' visits to generate market forecasts for the products or products and record an audio memo summarising his analysis. A production manager accessing the knowledge management system may seek information on said products or products and may either as an option or as a mandatory briefing have the system provide him with the marketing analyst's analysis of predicted future orders for said product or products which he may use in his capacity for planning production of such products. In each interaction with the system, the salesperson, the market analyst and the production manager have no need to converse directly to share collected and processed knowledge of customers' predicted requirements. This is particularly useful in global organisations where the production facilities and thus production managers are located remotely from the customers and thus salespersons. Equally, the market analysts may also be located remotely from either of the salespersons and production managers.

The information gathered by a salesperson as to a particular customer's requirements in the future for a particular product may also be used to create an entity briefing message for the next visit by a salesperson to that customer as an aide memoir to pursue an order for that product from that customer. The salesperson may be the same salesperson that provided the original intelligence about the customer's future requirements.

In this example implementation, the salesperson may also provide other intuitive insights about a customer such as whether the customer's trading levels appear healthy. Intuitive insights such as these may be stored in the knowledge management system until subsequent analysis by administrators or experts trigger an investigation of whether the customer's credit rating, for example, should be reviewed.

The foregoing are merely examples of implementations of the knowledge management system in accordance with the invention and should not be taken as limitative of its scope.

In conclusion, the present invention provides a method and system for supporting knowledge sharing using voice, through a variety of communication media including, fixed or mobile telephony, wireless and Voice over Internet Protocol.

The invention provides a knowledge sharing method for supporting mobile workers before, during and after visiting a location, organisation or individual as part of their day to day activities.

The invention enables a systematic method to capture information and insights communicated through voice, to organise the resulting content, provide access to and the use of, knowledge associated with a worker making a visit. In so doing, it also supports the creation of new knowledge related to the activities undertaken in the visit itself. It may also be extended to include other media such as photographic or video assets. Knowledge is captured through a combination of speech recognition and audio recordings.

The invention supports a worker calling it at the end of a visit, when they are asked a number of questions that relate to the activity undertaken during the visit. The questions are designed to support the development of specific knowledge and elicit verbal information and insights from the worker with the answer being recognised by a speech to text engine or recorded and stored for subsequent analysis.

The resulting content is organised using information about the location, organisation or individual being visited, the type of activity being undertaken, the person or organisation conducting the visit, and the type of question being asked. Pre-defined workflows manage the content, routing it to other workers or to experts for their analysis.

Captured knowledge is accessed by workers calling the system before and during a visit, by listening to an audio recording or text to speech synthesiser, and by experts accessing the knowledge base through an administration interface.

Creation of new knowledge is enabled by allowing an administrator or an expert to make specific information requests of workers visiting a location, organisation or individual, as well as by providing a database of visit related information, which can be analysed to discover new insights. Triggers and alerts can be set to monitor the visits recorded in the database and to act on these and other insights.

While there are many examples of systems for managing knowledge and of using speech recognition in communication applications, the present invention provides significant advantages over methods described in the art or in the public domain for managing knowledge associated with a visit to a location, organisation or an individual.

1. A knowledge management system having a database for storing knowledge specific to a plurality of entities, said database being arranged to provide stored knowledge to a user in response to said user providing an identity of one of said plurality of entities, said knowledge being provided to said user in audio form on a voice enabled interface between the user and the system, wherein the knowledge provided to said user is retrieved from the knowledge stored in the database specific to that entity and the knowledge stored in the database for an entity comprises, is based on or is derived from information provided by a user.

2. A knowledge management system as claimed in claim 1, wherein the knowledge stored in the database comprises at least one of data and audio recordings.

3. A knowledge management system as claimed in 1, wherein knowledge stored in the database for each entity is categorised.

4. A knowledge management system as claimed in claim 1, wherein an entity comprises at least one of a location, a person, an organisation, and a process.

5. A knowledge management system as claimed in claim 1, wherein the knowledge stored for an entity in the database comprises information provided by a previous user of the system.

6. A knowledge management system as claimed in claim 5, wherein the information provided by a previous user of the system is outputted to a subsequent user of the system as speech synthesised text on the voice enabled interface.

7. A knowledge management system as claimed in claim 1, wherein the system has a voice gateway for providing the voice enabled interface between the system and a user and the voice gateway has a voice recognition processor for processing user voice inputs to the system.

8. A knowledge management system as claimed in claim 1, wherein the system has an application server and the application server is arranged to enable a user to browse the knowledge stored for an entity in the database in response to the user identifying said entity.

9. A knowledge management system as claimed in claim 8, wherein the application server is arranged to enable a user to search the knowledge stored for an entity in the database in response to the user identifying the entity.

10. A knowledge management system as claimed in claim 8, wherein the application server and voice gateway are arranged to enable a user to search knowledge stored for an entity in the database by using spoken key words.

11. A knowledge management system as claimed in claim 8, wherein the application server issues to a user a request for information on a specific entity in response to said user identifying that entity.

12. A knowledge management system as claimed in claim 1, wherein a user connects to the voice enabled interface of the system by a telephony enabled device.

13. A knowledge management system as claimed in claim 12, wherein the user's telephony enabled device comprises any one of a plain old telephone system (POTS) handset connected to the voice gateway by a public switched telephone network (PSTN), a mobile telephony handset connected to the voice gateway via a mobile switching centre (MSC) and PSTN, an internet protocol (IP) telephony handset connected to the voice gateway by the Internet and a telephony enabled personal computer (PC) connected to the voice gateway by the internet.

14. A method of managing knowledge collection/retrieval in a system having a database for storing knowledge, comprises the steps of: arranging elements of stored knowledge in the database such that each element is associated with a specific one of a plurality of known entities; and providing one or more elements of stored knowledge to a user in response to said user providing an identity of one of said entities, the one or more elements of stored knowledge being outputted to the user on a voice enabled interface between the user and the system, wherein the one or more elements of stored knowledge provided to said user are retrieved from the elements of knowledge stored in the database associated with the identified entity and the knowledge stored for an entity in the database comprises, is derived from or is based on information provided by a user.

15. A method as claimed in claim 14, wherein the elements of stored knowledge comprise at least one of data and audio recordings.

16. A method as claimed in claim 14, wherein the elements of stored knowledge for each entity are categorised.

17. A method as claimed in claim 14, wherein an entity comprises at least one of a location, a person, an organisation and a process.

18. A method as claimed in claim 14, wherein the elements of stored knowledge for an entity comprises information provided by a previous user of the system.

19. A method as claimed in claim 18, wherein the information provided by a previous user of the system is outputted to a subsequent user of the system as speech synthesised text on the voice enabled interface.

20. A method as claimed in claim 14, wherein a voice gateway provides the voice enabled interface between the system and a user.
